(19) United States
(12) Patent Application Publication
(10) Pub. No.: US 2026/0177168 A1
(43) Pub. Date: Jun. 25, 2026

(54) REINFORCEMENT LAYER AND METHODS

(71) Applicant: Polyflow LLC, Midland, TX (US)

(72) Inventors: Linfa Zhu, Katy, TX (US); Zhimin Tan, Katy, TX (US); Liang Yu, Katy, TX (US)

(21) Appl. No.: 19/000,046

(22) Filed: Dec. 23, 2024

(51) Int. Cl. F16L 11/08; B29C 63/10; B29L 23/00

(52) U.S. Cl. CPC F16L 11/082; B29C 63/105; B29L 2023/22

(57) ABSTRACT

A method of manufacturing a flexible pipe member, a flexible pipe member, and apparatus for providing a plurality of flexible tape elements at a desired location are disclosed. The method comprises providing a tubular layer; for each of at least one precursor reinforcement tape, via a respective at least one separator element, separating at least a first strip portion of a respective precursor reinforcement tape from a further strip portion thereby providing a plurality of minor tapes, each corresponding to a respective strip portion, disposed in an edge wise side-by-side relationship; and helically winding the minor tapes simultaneously in an edge wise side-by-side relationship over an outer surface of the tubular layer thereby providing a reinforcement layer over the tubular layer.

### FIELD

The present invention relates to a method and apparatus for splitting and winding a tape element to provide a reinforcement layer. In particular, but not exclusively, the present invention relates to providing reinforced thermoplastic pipe (RTP) body that includes at least one reinforcement layer provided by separating a precursor tape into multiple minor tapes arranged edge wise side-by-side that have near-zero gap between them and helically winding the minor tape elements simultaneously over an underlying layer to provide a reinforcement layer.

### BACKGROUND

From time to time, tape elements are used to make tubular structures. For example, flexible elongate tapes may be wound around an underlying support thus producing a layer of tape. One type of tubular structure that includes one or more helically wound elongate tapes is reinforced thermoplastic pipe (RTP) which is used in the Oil & Gas industry to transport hydrocarbons from one location to another. RTP may be used onshore or offshore.

RTP may either be of an unbonded construction, where the layers of RTP body are unbonded to each other, i.e. an inner fluid containing polymer liner layer is not bonded to a reinforcement layer, which is in turn not bonded to an outer protective sheath polymer layer, or of a bonded construction, i.e. all layers are bonded to each other as part of the pipe manufacturing resulting in a pipe which is in effect a single, consolidated layer comprising sub-layers. RTP of either type may be suitable for use in transporting and/or distributing oilfield fluids, such as water, gas (methane, ethane, CO₂ etc.) and / or the transport and distribution of hydrocarbon liquids, or other fluids such as hydrogen may be used onshore (over land) or in very shallow water applications (for instance less than 50m water depth). That is to say RTP may be for transporting production fluids.

Structurally, multilayer RTP may have a non-complex construction, often comprising two or more polymer layers each of which may be similar or different polymer types. The American Petroleum Institute Specification 15S is a reference for an example of these types of pipes. The inner and outer polymer layers (often termed as liner and protective sheath respectively) are extruded polymers of at least one type of polymer. In certain embodiments for some applications the inner polymer layer may comprise sub-layers similar or different polymer compositions which are co-extruded to form a liner.

Conventionally a reinforcement layer of an RTP may be created by helically winding one or more tapes around an underlying layer (such as a liner). The reinforcement layer usually adds rigidity to the RTP, allowing it to better resist forces that act on it including internal pressure, external pressure, tension, compression, torsion, bending moments and the like. However, it has been noted that reinforcement layers formed by winding tape(s) are prone to failure.

From time to time manufacturers of pipe body wish to wind tape to form a layer for a particular reason. However there are limited commercially available tapes of any given width/thickness. It has until now proved expensive to provide windable flexible tapes in desired widths without costly manufacturing steps or pre ordering bespoke dimensions from an original tape manufacturer.

### SUMMARY

It is an aim of certain embodiments disclosed herein to at least partly mitigate one or more of the above-mentioned problems.

It is an aim of certain embodiments disclosed herein to mitigate the creation of micro cracks that would otherwise be found in the current RTP pipes after bending.

It is an aim of certain embodiments disclosed herein to provide apparatus for manufacturing RTP containing tape layer(s) wherein the RTP is more able to bend without developing micro cracks in the tape layer(s).

It is an aim of certain embodiments disclosed herein to provide an improved RTP with minimal effect on either the existing manufacturing process or the RTP construction itself.

It is an aim of certain embodiments of the present invention to provide a method for manufacturing improved RTP without significantly increasing material costs or complicating the manufacturing process relative to commonly used techniques.

It is an aim of certain embodiments disclosed herein to reduce the average gap between helically wound tape elements forming a layer of RTP body relative to known techniques.

It is an aim of certain embodiments disclosed herein to provide zero (or a negligible) gap between certain neighbouring windings of a tape element forming a layer of RTP body.

It is an aim of certain embodiments to provide a winding station that can helically wind tapes simultaneously to form a layer around an underlying tubular surface and which can utilise a supply tape as a precursor tape and from that make multiple windable smaller (in the width dimension) tapes that can be wound together side by side.

It is an aim of certain embodiments to provide roller elements that can be retrofitted to existing winding stations to replace a respective roller or add an additional roller and which provides the ability to separate portions of an incoming supply tape into two or more smaller (in the width dimension) tapes which can thereafter be wound to form a respective layer.

It is an aim of certain embodiments disclosed herein to integrate apparatus for providing a tape layer with enhanced micro-crack mitigation properties into the manufacturing process for producing RTP body.

According to a first aspect there is provided a method of manufacturing a flexible pipe member, comprising: providing a tubular layer; for each of at least one precursor reinforcement tape, via a respective at least one separator element, separating at least a first strip portion of a respective precursor reinforcement tape from a further strip portion thereby providing a plurality of minor tapes, each corresponding to a respective strip portion, disposed in an edge wise side-by-side relationship; and helically winding the minor tapes simultaneously in an edge wise side-by-side relationship over an outer surface of the tubular layer thereby providing a reinforcement layer over the tubular layer.

Aptly, the method further comprises: drawing supply tape, for providing respective reinforcement tape, that is in an unslit state and that has a supply tape edge-to-edge width from a respective roll of supply tape supported via a respective spool member; as the spool member is rotated around the tubular layer, urging supply tape past a plurality of separator elements that each comprise a blade having a respective cutting edge, said separator elements being disposed in a spaced apart parallel relationship and at a location between the spool member and a touchdown zone where incoming minor tape windings touch the outer surface; and slitting the supply tape via blades of the separator elements thereby separating strip portions of precursor reinforcement tape.

Aptly, the method further comprises: supporting the precursor reinforcement tape between the spool member and the separator elements via at least one guide roller element that each rotate around the tubular layer in a constant spaced apart relationship with the spool member; and via a final guide roller element that is a guide roller element of the at least one guide roller element that immediately precedes the separator elements in a precursor reinforcement tape pathway, directing precursor reinforcement tape to the separator elements, said separator elements being supported on a support member that has a constant spaced-apart relationship with a rolling axis of the final guide roller element.

Aptly, the method further comprises: drawing supply tape, for providing respective reinforcement tape, that is in an unslit state and that has a supply tape edge-to-edge width from a respective roll of supply tape supported via a respective spool member ; as the spool member is rotated around the tubular layer, urging supply tape over a guide roller element, that comprises at least one circumferentially extending blade that comprises a respective cutting edge and that extends radially outwardly from the guide roller element, disposed at a location between the spool member and a touchdown zone where incoming minor tape windings touch the outer surface; and slitting the supply tape via each cutting edge thereby separating strip portions of precursor reinforcement tape.

Aptly, the method further comprises: supporting the precursor reinforcement tape between the spool member and the separator elements via at least one guide roller element that each rotates around the tubular layer in a constant spaced apart relationship with the spool member; and via a final guide roller element that is a guide roller element of the at least one guide roller element that immediately precedes the touchdown zone in a precursor reinforcement tape pathway, slitting precursor reinforcement tape via the at least one circumferentially extending blade and supporting and thereby guiding each resultant minor tape on a region of a respective at least one circumferentially extending guide surface that extends circumferentially around the final guide roller element.

Aptly, the method further comprises: separating strip portions via slitting the precursor reinforcement tape thereby simultaneously cutting through precursor reinforcement tape having a first edge-to-edge width thereby simultaneously cutting continuous through cuts made in an axial direction associated with a length of precursor reinforcement tape via at least one blade, that optionally comprises a plurality of spaced apart blades, thereby providing a plurality of minor tapes each having an edge-to-edge width less than the first edge-to-edge width.

According to a second aspect there is provided a flexible pipe member for transporting production fluids, comprising: a tubular layer comprising an outer surface; and a reinforcement layer, over the tubular layer, that comprises a plurality of flexible minor tapes helically wound around the outer surface; wherein in an axial cross section through the reinforcement layer, the minor tapes repeat a pattern of abutting minor tapes, comprising at least one pair of minor tapes being disposed in an edge wise side-by-side abutting relationship, and overlapped minor tapes comprising a minor tape wound flat against the outer surface and an adjacent minor tape having an overlapping edge region wound partially overlapping an overlapped edge region of the adjacent wound minor tape that is wound flat.

Aptly, the pattern in the axial cross section comprises a common number of abutting minor tapes and overlapped minor tapes along a whole or at least 60% of a whole length of the reinforcement layer.

Aptly, the pattern in the axial cross section comprises at least a repeated first integer number of abutting minor tape windings and a repeated further integer number, that is different from the first integer number, of abutting minor tape windings that are separated from the abutting minor tape windings of the first integer number of abutting minor tape windings by a pair of overlapping minor tape windings that are partially overlapping at respective edge regions.

Aptly, each minor tape element is a helically wound tape wound at a common pitch and a common winding angle with respect to a primary axis associated with an axial length of the tubular layer.

Aptly, the plurality of minor tapes are wound as a set of minor tapes, each minor tape winding in a set having at least one edge that abuts with an edge of an adjacent minor tape winding of the set.

Aptly, at least one extreme minor tape, that is a minor tape in a set that is on a lateral width-wise extremity of the minor tapes in a set of minor tapes, partially overlaps with or partially underlies with an adjacent extreme minor tape of an adjacent set of minor tape windings.

Aptly, each minor tape has an edge-to-edge width of between about around 10mm to 50mm that is a common width along a whole axial length of the minor tape.

Aptly, the precursor reinforcement tape has a thickness to width aspect ratio of between 1:500 and 1:50 and the minor tapes each have a respective thickness to width aspect ratio of between 1:100 and 1:10.

According to a third aspect there is provided apparatus for providing a plurality of flexible tape elements at a desired location, comprising: a guide roller element comprising a guide roller body that includes at least one circumferentially extending cylindrical guide surface region on a radially outer surface of the guide roller element, and at least one shaft member associated with a respective roller body rotation axis; and at least one separator element each supported in a respective preset position in relation to the guide surface region and disposed to separate strip portions of a precursor reinforcement tape for providing a plurality of flexible minor tapes, each having a constant longitudinal cross-section, in an edge wise side-by-side relationship.

Aptly, each separator element of the at least one separator element comprises a blade, with a respective cutting edge, that extends from a support beam supported at at least one end to the shaft member.

Aptly, the at least one separator element comprises a plurality of blades, each having a respective cutting edge, disposed in a commonly spaced apart relationship, a common interblade spacing associated with the spaced apart relationship being an integral division of an expected width of an incoming precursor reinforcement tape to thereby separate a precursor reinforcement tape into an integral number of equal width minor tapes.

Aptly, said at least one circumferentially extending cylindrical guide surface region comprises a single cylindrical guide surface region that is smooth or includes one or more circumferentially extending ribs or grooves that is for presenting a support surface to an incoming precursor reinforcement tape.

Aptly, the at least one separator element comprises a plurality of separator elements and each separator element of the plurality of separator elements comprises a circular radially outwardly extending blade each having a respective radially extreme cutting edge and that extends circumferentially around the guide roller body and is disposed at a respective side of at least one associated cylindrical guide surface region.

Aptly, the at least one guide surface region comprises a plurality of guide surface regions that are coaxial and all lie on an imaginary cylinder of common radius and have an equal width, said guide surface regions being spaced apart via circular blades.

According to a fourth aspect there is provided a reinforcement layer winding station, comprising: a driven rotatable core member that has a central through passageway aligned along an axis about which the core member is rotatable; at least one spool member, for holding a respective reel of precursor reinforcement tape, supported by, and rotatably drivable around the through passageway with the core member; at least one satellite guide roller element that moves with the core member for guiding a pathway of a reinforcement tape; and a final guide roller element that immediately precedes a touchdown zone in a tape pathway and that comprises at least one separator element for separating strip portions of an incoming precursor reinforcement tape.

Certain embodiments provide a method of manufacturing RTP body that reduces the incidence of micro-cracking, particularly after bending the RTP, when compared to conventional RTP body.

Certain embodiments provide apparatus that can be used during the manufacture of RTP body having at least one layer of helically wound tape that helps to mitigate micro crack formation in the tape windings. It has now surprisingly been found that the micro cracks are forming in the existing tape windings due to the width of the tape used and/or the non-zero gap between edges of neighbouring windings of the tape. Certain embodiments of the present invention make use of this discovery.

Certain embodiments provide apparatus that separates an incoming tape element into two or more distinct outgoing tape elements, whereby the outgoing tape elements have an edgewise width that is narrower than the incoming tape element and the outgoing tape elements are arranged in a side-by-side relationship without a gap between them.

Certain embodiments provide apparatus that enables narrower tape elements to be helically wound to form a layer of RTP body than conventional techniques without significantly affecting many parameters of the winding process (e.g. requiring more revolutions, storing more spools of tape, or the like).

Certain embodiments provide a method that reduces the average gap between helically wound tape elements forming a layer of RTP body.

Certain embodiments provide zero (or a negligible) gap between certain neighbouring windings of a tape element forming a layer of RTP body.

Certain embodiments provide a method that continuously splits a wide tape into several narrower tapes soon before the tape is wound to form a layer of RTP. This helps to reduce or near eliminate the gap between windings of tape. An added benefit is that the wide tape is easier to store on a spool, pre-manufacture, compared to storing pre-cut narrow tape.

Certain embodiments help minimise a gap between neighbouring windings of tape when those windings are helically wound to provide a tape layer that optionally is a reinforcement layer.

Certain embodiments provide a new roller with tape splitter that could replace an existing roller used in the process for manufacturing RTP body with small cost and minimum impact to the existing manufacturing procedure.

Certain embodiment of the present invention help avoid micro cracks occurring at wrapped tape edges adjacent a gap. Certain embodiments thus help avoid micro cracks that introduce weaknesses into the RTP body which can propagate into larger cracks. Avoidance/reduction in number of micro cracks significantly increases the strength of the RTP and makes it less vulnerable to sudden catastrophic failure whilst in use.

Certain embodiments provide a new manufacturing process which includes a new tape splitter which can be used in the RTP pipe production line to continuously split wide tapes into several narrower tapes.

Certain embodiments provide a winding station that can helically wind tapes simultaneously to form a layer around an underlying tubular surface and which can utilise a supply tape as a precursor tape and from that make multiple windable smaller (in the width dimension) tapes that can be wound together side by side.

Certain embodiments provide roller elements that can be retrofitted to existing winding stations to replace a respective roller or added to existing winding stations as an additional roller and which provide the ability to separate portions of an incoming supply tape into two or more smaller (in the width dimension) tapes which can thereafter be wound to form a respective layer with little or no gaps between all or most adjacent tape windings.

Certain embodiments provide a new manufacturing process with tape splitter that continuously splits a wide tape on the fly during manufacturing which can a) create a zero gap condition between split tape edges after wrapping on the pipe, b) save time to prepare narrower tapes, or the like.

### BRIEF DESCRIPTION OF THE DRAWINGS

Certain embodiments of the present disclosure will now be described hereinafter, by way of example only, with reference to the accompanying drawings in which:

FIG. 1 illustrates a cross-section of reinforced thermoplastic pipe (RTP) body;

FIG. 2 illustrates certain uses of RTP;

FIG. 3 illustrates the internal construction of a segment of RTP body;

FIG. 4 illustrates a set of minor tapes;

FIGS. 5A and 5B illustrate how multiple minor tapes may simultaneously be helically wound;

FIG. 6 illustrates an RTP body manufacturing process;

FIG. 7 illustrates another view of the RTP body manufacturing process;

FIG. 8 illustrates diagrammatically the path of tape elements during the RTP body manufacturing process; and

FIGS. 9A and 9B illustrate an alternative RTP body manufacturing process.

In the drawings like reference numerals refer to like parts.

### DETAILED DESCRIPTION

Throughout this description, reference will be made to a type of flexible pipe known as reinforced thermoplastic pipe (RTP). It is to be appreciated that certain embodiments may also be applicable to use with a wide variety of flexible pipe / flexible pipe members. For example, certain embodiments can also be used with respect to flexible pipe body and associated end fittings of the type which is manufactured according to API 17J. Such flexible pipe is often referred to as unbonded flexible pipe. Certain embodiments may also be used with respect to thermoplastic composite pipe (TCP). Certain embodiments may be used to create one or more layers for tubular structures.

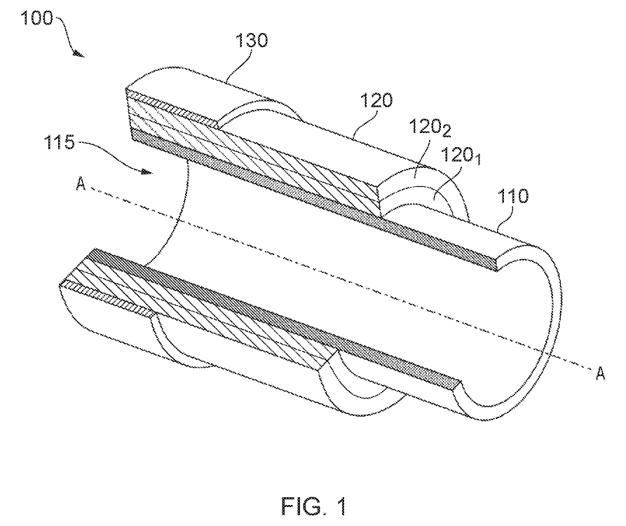

It will be understood that the illustrated RTPs are an assembly of a portion of RTP body and one or more end fittings (not shown) in each of which a respective end of RTP body is terminated. FIG. 1 illustrates unbonded pipe body 100 which has a central axis marked by A-A in FIG. 1. Although a number of particular layers are illustrated in FIG. 1, it is to be understood that certain embodiments are broadly applicable to coaxial pipe body structures including two or more layers manufactured from a variety of possible materials. Unbonded pipe body 100 may include one or more sub-layers comprising composite materials that collectively form a tubular reinforcement layer. It is to be further noted that the layer thicknesses are shown for illustrative purposes only. As used herein, the term “composite” is used to broadly refer to a material that is formed from two or more different materials, for example a material formed from a matrix material and reinforcement fibres. Pipe body may include one or more layers of a single material, forming a tubular uniform layer.

A tubular composite layer is thus a layer having a generally tubular shape formed of composite material. Alternatively, a tubular composite layer is a layer having a generally tubular shape formed from multiple components one or more of which is formed of a composite material. The layer or any element of the composite layer may be manufactured via an extrusion, pultrusion or deposition process or, by a winding process in which adjacent windings of tape which themselves have a composite structure are bonded together with adjacent windings.

The RTP body 100 illustrated in FIG. 1 is an example of a flexible pipe member. Aptly a flexible pipe member is a pipe suitable for transporting production fluids in the oil and gas industry. The RTP body 100 includes a fluid retaining liner 110 which is a non-porous tubular layer that provides a boundary for any conveyed fluid. Aptly the fluid retaining liner 110 is an example of a tubular layer. The liner 110 is made of high-density polyethylene (HDPE) and defines an internal pipe bore 115 of the RTP body. It will be appreciated that in other embodiments, the liner 110 may be made of a different polymer (for example polyethylene of raised temperature resistance (PERT), polyethylene, polypropylene, polyamide, or the like). Additionally it will be appreciated that there are alternatives to extrusion for manufacturing a tubular layer. It is to be understood that the liner 110 may itself comprise a number of sub-layers in some embodiments. Aptly the liner 110 may be manufactured with an additional barrier layer made of polyamide (PA), polyphenylene sulfide (PPS), or the like. The optional barrier layer may provide additional chemical and permeation resistance. Aptly the optional barrier layer may be coextruded with the liner 110.

The internal diameter of the liner 110 shown – which may also be referred to as defining the bore 115 – is 6 inches (152.4 mm). In use the bore 115 constrains fluid that passes through the RTP body 100. It will be appreciated that in other embodiments the internal diameter of the pipe bore 115 may be larger or smaller in diameter (e.g., around 4 inches / 101.6 mm, around 8 inches / 203.2 mm, or the like). The pipe bore 115 of RTP body 100 is hollow. Bore fluid is able to flow in a direction broadly parallel with the central axis A-A of RTP body 100. It will be appreciated that RTP body 100 may be deformed by external or internal forces without breaking. External forces may deform RTP body 100 and determine a shape adopted by the RTP.

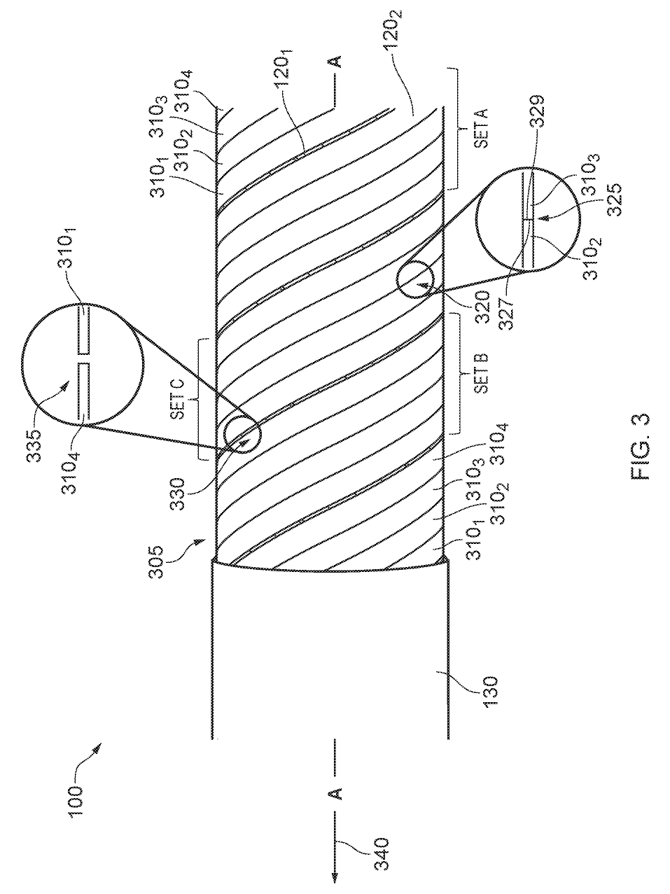

The embodiment of RTP body as shown in FIG. 1 includes a reinforcement layer 120. The reinforcement layer 120 provides structural support to RTP body 100. The reinforcement layer 120 may help to improve the resistance of RTP body to internal or external pressures, tensile forces, torsion, or the like. The reinforcement layer 120 is coaxial and radially external to the liner 110. In the present example, there are two reinforcement layers 120_{1,2} each made from a helically wound reinforcement tape layer. The two layers are counter-wound. In other embodiments there many be any number of reinforcement tape layers 120. Aptly the reinforcement layer 120 may also have other sub-layer components. The construction of the reinforcement layer 120 is shown in more detail in FIG. 3. It will be appreciated that in some embodiments, the reinforcement layer 120 may be composed of a plurality of sub-layers.

In FIG. 1, the reinforcement layers are an underlying tape layer 120₁ helically wound in a clockwise direction and an overlying tape layer 120₂ helically wound in an anticlockwise direction. Together the underlying 120₁ and overlying 120₂ tape layers form a pair. Each tape layer 120_{1,2} is formed from multiple fibreglass tapes. That is to say the tape used to form the underlying 120₁ and overlying 120₂ tape layers is composed of glass filaments (optionally glass filament strands) adhered to or encapsulated within a polymer sheet (e.g. polyethylene or polypropylene or nylon or PPS or PVC or PVDF or PFA or PEEK or PTFE, polyester, vinyl ester, or the like). Aptly the fibreglass tape fibres may be interwoven to form a mesh. Aptly the glass filaments, strands or mesh may be surrounded by an epoxy resin. Aptly a composite tape having a different filament (e.g., aramid fibres, carbon fibre, or the like) may be used instead of the fibreglass tape.

Alternatively the tape may be formed from a number of steel wires (or alternatively any metal/alloy, etc) aligned with the longitudinal axis of the tape and each embedded in a matrix material. In certain embodiments, the matrix material is a thermoplastic material. In certain embodiments, the thermoplastic material is polyethylene or polypropylene or nylon or PPS or PVC or PVDF or PFA or PEEK or PTFE, alloys of such materials, or alloys of such materials with reinforcing fibres manufactured from one or more of ceramic, carbon, graphene, carbon nanotubes, aramid, steel, nickel alloy, titanium alloy, aluminium alloy or the like or fillers manufactured from ceramic, carbon, metals, buckminsterfullerenes, metal silicates, carbides, carbonates, oxides or the like.

RTP body also includes an outer sheath 130: a non-porous tubular polymer layer used to protect the pipe against penetration of seawater and other external environments, corrosion, abrasion, ultraviolet (UV), and mechanical damage. The outer sheath 130 is coaxial to the reinforcement layers 120 and the liner 110. As shown in FIG. 1, the outer sheath 130 is not bonded to the reinforcement layer 120. The outer sheath is the outermost region of RTP body 100. The outer sheath 130 is made of HDPE. The outer sheath 130 may be formed by extruding HDPE into a tubular shape directly onto the reinforcement layers 120. It will be appreciated that in other embodiments, the outer sheath may be made of polymer or other durable non-porous material (e.g., polyethylene of raised temperature resistance (PERT), polyethylene, polypropylene, polyamide, or the like). Also, the tubular body consolidated to form the outer sheath 130 may be made by any known alternative process such as tape winding.

It will be appreciated that whilst the embodiment illustrated in FIG. 1 is a segment of unbonded RTP body 100, that unbonded RTP body 100 may later be consolidated to form bonded RTP body. Depending on the application, bonded RTP body may offer some benefits. Alternatively select lengths of the unbonded RTP body 100 may be consolidated to form bonded RTP body 100 whilst other lengths of the same segment of unbonded RTP body 100 may remain unconsolidated.

In general, each reinforced thermoplastic pipe (RTP) comprises at least one portion, referred to as a segment or section, of RTP body (which may be bonded or unbonded) together with an end fitting located at at least one end of the RTP. The end fitting provides a mechanical device which forms the transition between RTP body and a connector. The different pipe regions as shown, for example, in FIG. 1 are terminated in the end fitting in such a way as to transfer the load between RTP body and the connector.

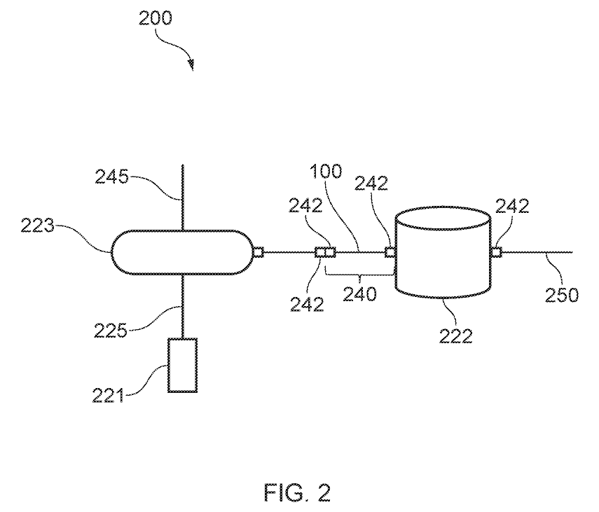

FIG. 2 illustrates an onshore assembly 200 suitable for transporting production fluid such as oil and/or gas and/or water from a wellhead production tree 221 to a storage facility 222 via a three-phase separator 223. For example, in FIG. 2, the production tree 221 includes a wellhead flow line 225. The flexible flow line 225 includes an RTP, wholly or in part, resting on the ground or buried in a trench and used in a static application. The onshore assembly 200 is provided as a spoolable pipe, that is to say an RTP 240 connecting the three-phase separator 223 to the storage facility 222. RTP 240 may optionally be composed of a segment of RTP body 100 connected to one or more end fittings 242. Aptly end fittings 242 may be joined end to end. Aptly in some embodiments one end fitting 242 may be connectable on each side to a segment of RTP body 100.

The onshore assembly 200 in FIG. 2 illustrates how portions of the RTP can be utilized as a gas export pipe 245 or an oil export pipe 250. The portions of the RTP in the onshore assembly 200 can have different pipe diameters, can withstand different pressures, and can have other specification differences according to their use. Some, though not all, examples of such configurations can be found in API 15S. It will be appreciated that in other embodiments, the RTP, RTP body and the end fittings may be used for different purposes such as water disposal pipes, gas injection pipes, produced gas pipes, CO₂ export pipes, and the like.

FIG. 3 illustrates the internal construction of a section of RTP body 100. In more detail, FIG. 3 shows an outer surface 305 of the reinforcement layer 120 of the RTP body 100 with the outer sheath 130 partially removed. The overlying tape layer 120₂ is formed from successive clockwise windings of three sets of tapes (set A, set B and set C) that are wound over the underlying tape layer 120₁ (an example of a tubular layer). FIG. 3 also shows how the underlying tape layer 120₁ is formed of tape elements that are anti-clockwise wound. Aptly the tapes could be clockwise wound. Collectively the tapes provide a single layer that serves to reinforce the RTP body 100, for example, from internal or external pressure, tensile or compressive force, or the like. Aptly the tape layers 120 are also flexible to some degree. It will be appreciated that alternatively any number of sets of tapes could collectively form the overlying tape layer 120₂.

In the example illustrated in FIG. 3, each set of tapes (e.g., set A, set B, set C, etc) is made up of four minor tapes 310. The minor tapes 310 are wound at a lay angle of about 45°. Aptly the minor tapes 310 may alternatively be wound at a lay angle of between 10° and 80°. Aptly the overlaying tape layer 120₂ may alternatively be wound directly on the liner 110 (another example of a tubular layer). That is to say there may alternatively be only one layer of wound reinforcement tape.

Each minor tape 310 is about 40 mm wide. Aptly a minor tape 310 may have a width (defined between two laterally opposed edges) of between around 25 mm and 50 mm, or between around 10 mm and 80 mm, or the like. Each minor tape 310 has a thickness (defined between two vertically opposed surfaces) of about 2 mm. Aptly a minor tape 310 may have a thickness of between 0.5 mm and 1 mm, or between 0.1 mm and 3 mm, or the like. Aptly there may be two, three, five, six or more minor tapes 310 in a given set of tapes. From the left, as illustrated in FIG. 3, each set of tapes has: a first minor tape 310₁ at a left lateral extremity of the set, a second minor tape 310₂ directly to the right of the first minor tape, a third minor tape 310₃ directly to the right of the second minor tape, and a fourth minor tape 310₄ directly to the right of the third minor tape at a right lateral extremity of the set.

Within a set of tapes (for example set C), adjacent minor tapes 310 are disposed in an edge wise side-by-side relationship. At an intra-set tape boundary 320, as illustrated in FIG. 3, the adjacent minor tapes 310 abut one another without overlapping. That is to say each intra-set tape boundary 320 shown in FIG. 3 has zero gap 325. For example as shown in set C (FIG. 3), the second minor tape 310₂ has been helically wound in an edge wise side-by-side relationship with the third minor tape 310₃ such that a right edge 327 of the second minor tape 310₂ is in contact with a left edge 329 of the third minor tape 310₃. Aptly the zero gap 325 may in fact be a negligible gap in the intra-set tape boundary 320.

Between different sets of tapes (for example between set B and set C), adjacent extreme minor tapes 310 are disposed in a spaced-apart edge wise side-by-side relationship. At an inter-set tape boundary 330, as illustrated in FIG. 3, the adjacent extreme minor tapes 310 from their respective sets of tapes have a non-zero gap 335 between them. For example as shown between sets B and C (FIG. 3), the fourth (extreme right hand) minor tape 310₄ of set B is separated by the non-zero gap 335 from the adjacent first (extreme left hand) minor tape 310₁ of set C. The non-zero gap 335 is about 2 mm across and is due to the accuracy limits of the winding machine that wraps neighbouring windings of tape around an underlying layer, as will be discussed later in more detail. Aptly the non-zero gap 335 is about 0.5 mm to 4 mm, or 0.1 to 10 mm, or the like. Aptly in some instances adjacent extreme minor tapes 310 between different sets of tapes may overlap. Aptly the non-zero gap 335 may be replaced by an overlapping region in which a winding of a first minor tape 310 is underlying a winding of an overlying adjacent second minor tape 310. In that case one extreme minor tape 310 may underlie an adjacent extreme minor tape 310. It will be appreciated that in such cases it may be possible to infer the winding direction from the arrangement of the underlying and overlying extreme minor tapes 310.

During manufacturing, as the minor tapes 310 are wound around an underlying layer (in this case the underlying tape layer 120₁) the resulting product is driven in an output direction 340 (to the left in FIG. 3).

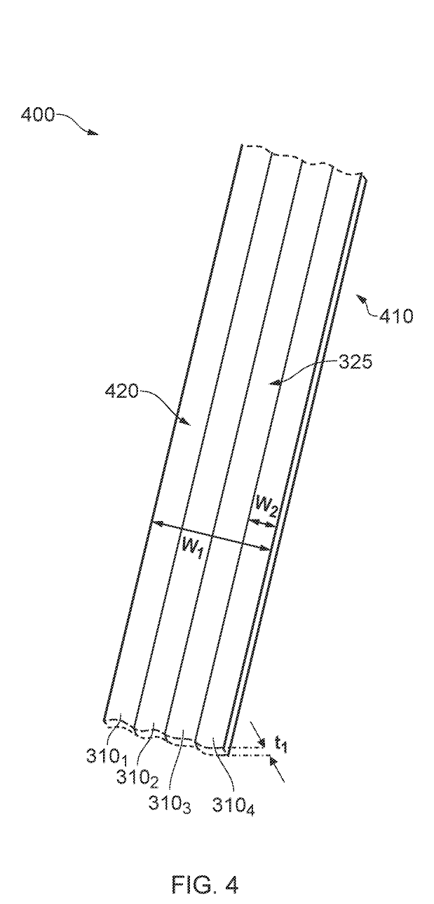

The following FIGS. 4-9 will now outline how the unbonded RTP body 100 illustrated in FIGS. 1 to 3 may be manufactured.

FIG. 4 illustrates a set 400 of minor tapes 310 used to provide the three sets (set A, set B and set C) shown in FIG. 3. Aptly the set shown in FIG. 4 could be wound to provide any set. Aptly the set could alternatively have two, three, five, six, or more minor tapes 310. Aptly the set 400 is an example of a slit reinforcement tape.

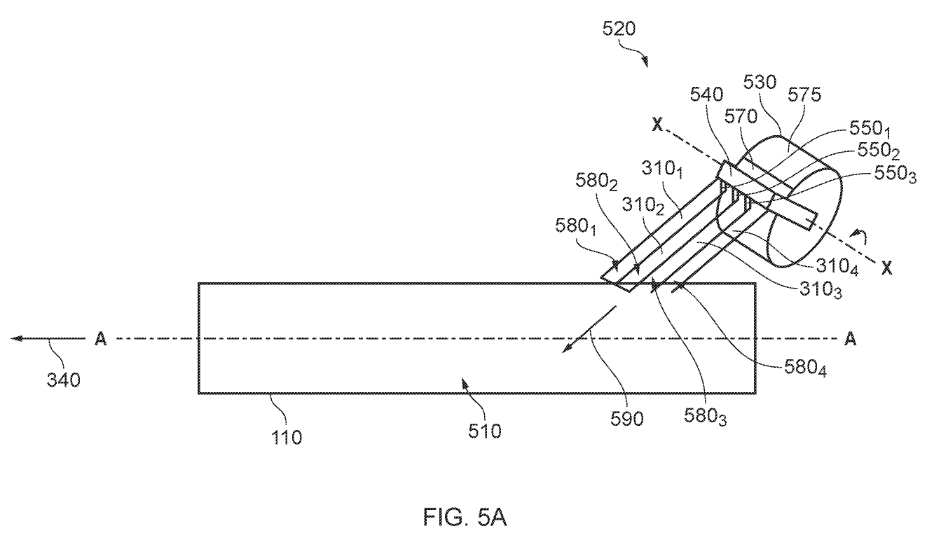

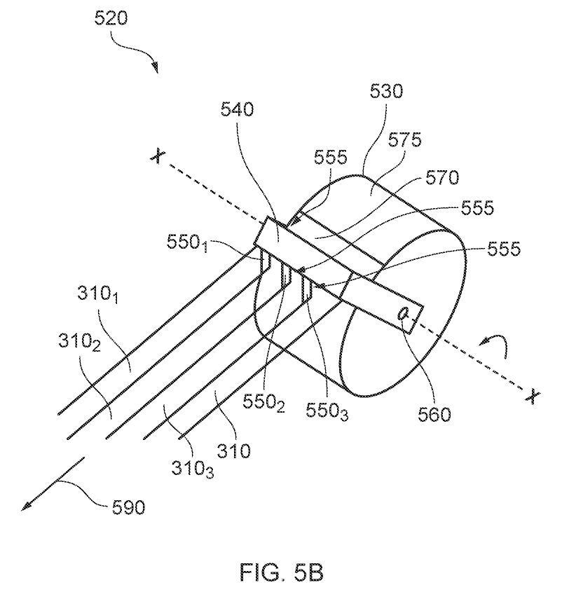

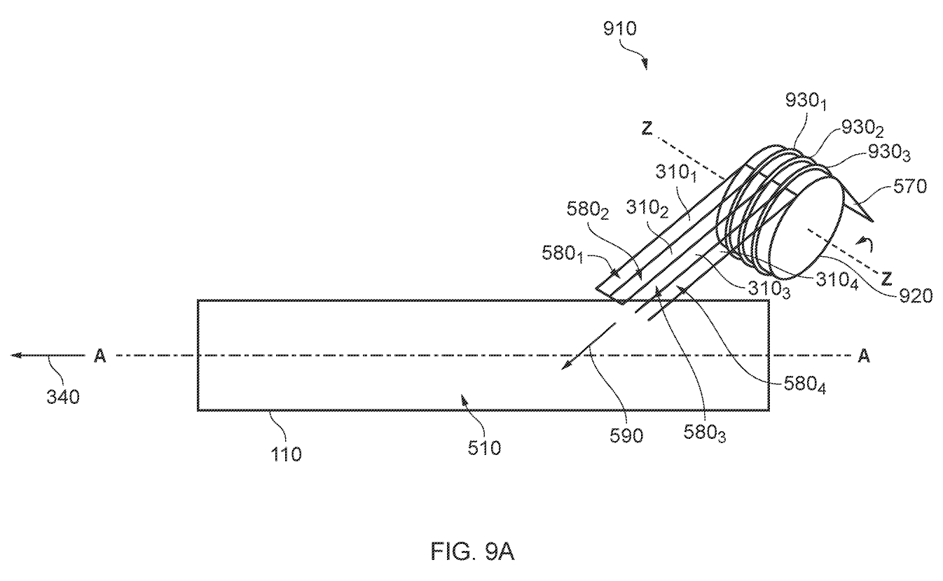

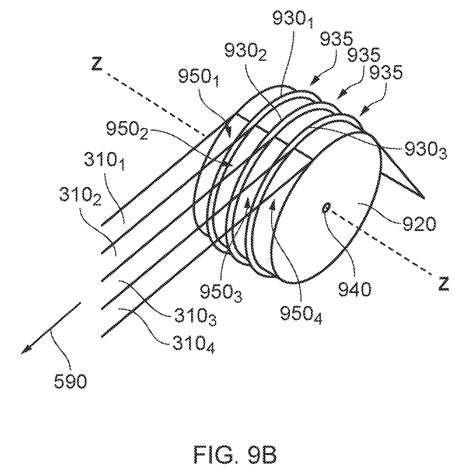

The set 400 is formed by splitting a single precursor reinforcement tape into four equally sized minor reinforcement tapes 310₁₋₄. The set 400 may be split as shown in FIG. 5A, or in FIG. 9A, or according to any other method for slicing tape. Aptly the set 400 may be formed by using a laser cutter, plasma cutter, or the like to provide minor reinforcement tapes 310₁₋₄. During the manufacture of RTP body 100, as illustrated in FIG. 5A for example, the set 400 is split into minor tapes 310 shortly before being wound. This helps to maintain the zero gap 325 between adjacent intra-set minor tapes which have little opportunity to separate from one another.

The set 400 has a set width w₁ of about 150 mm. Each minor tape 310 has a minor tape width w₂ of about 37.5 mm (roughly 40 mm). Aptly each minor tape 310 has a minor tape width w₂ of between around 25 mm and 50 mm, or between around 10 mm and 80 mm, or the like. It will be appreciated that the set width w₁ of the set 400 depends on the minor tape width w₂ and the number of minor tapes 310 in the set 400. It will be appreciated that whilst FIG. 4 shows each minor tape 310 having a common width equal to the minor tape width w₂, alternatively the width of each minor tape 310 in a set 400 may vary. For example the width of the first minor tape 310₁ and the third minor tape 310₃ may be a first width value whilst the width of the second minor tape 310₂ and the fourth minor tape 310₄ may be a second width value. Any other combination of two, three, or more different widths of minor tape elements may alternatively be used.

Each minor tape 310 has a minor tape thickness t₁ defined between a bottom face 410 and a vertically opposed upper face 420. The minor tape thickness t₁ of the minor tapes 310 shown in FIG. 4 is about 2 mm. Aptly the minor tape thickness t₁ may be between 0.5 mm and 1 mm, or between 0.1 mm and 3 mm, or the like. The minor tape 310 shown in FIG. 3 has a thickness-to-width aspect ratio (t₁:w₂) of about 1:20. By contrast the precursor reinforcement tape that the minor tapes 310 are formed from has a thickness-to-width ratio of about 1:80. Aptly the minor tapes 310 may have an aspect ratio (t₁:w₂) of between about 1:10 and 1:100. Aptly the precursor reinforcement tape may have an aspect ratio (t₁:w₁) of between about 1:50 and 1:500. It will be appreciated that in general the aspect ratio of the minor tape 310 will be equal to the aspect ratio of the precursor reinforcement tape divided by the number of minor tapes 310 formed.

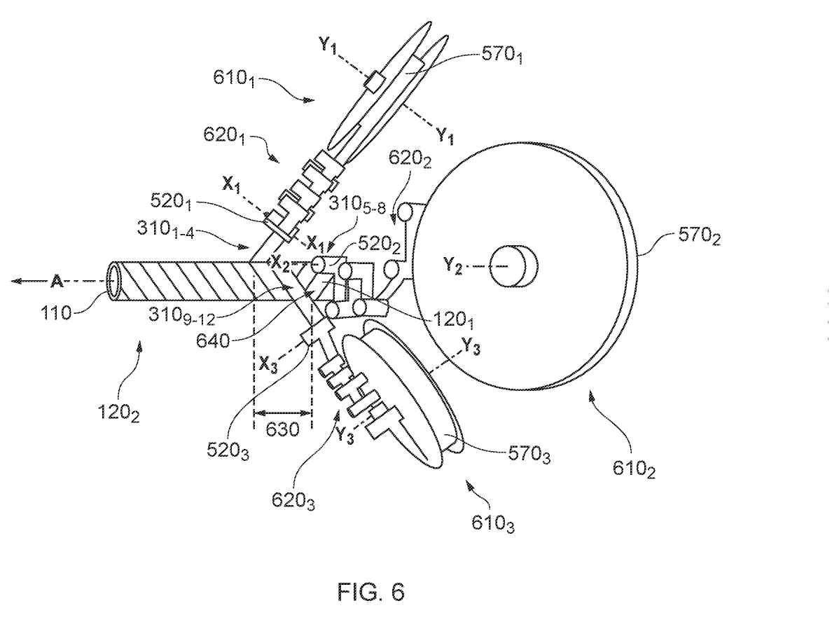

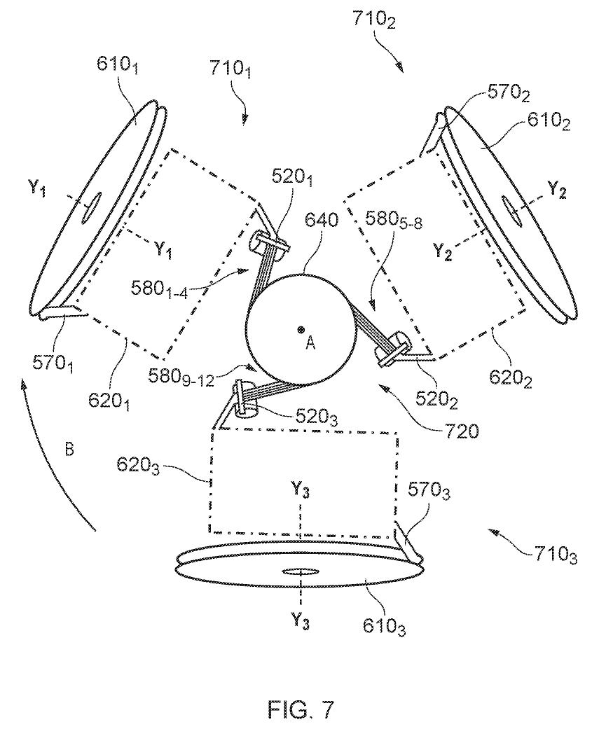

FIGS. 5A and 5B illustrate how a precursor tape is split into strip portions and helically wound as part of a manufacturing process for providing RTP body 100 (or any flexible pipe member). In particular, FIG. 5A illustrates how one set 400 of minor tapes 310 is simultaneously helically wound in an edge wise side-by-side relationship over an outer surface of a tubular layer thereby providing a reinforcement layer over the tubular layer. The minor tapes 310 are wound in a clockwise direction over an underlying liner 110 (an example of a tubular layer) at a lay angle of about 45°. The liner 110 defines the central axis A-A around which the minor tapes 310 are wound. Aptly the set 400 of minor tapes 310 may alternatively be wound at a lay angle of between 10° and 80°. It will be appreciated that the step shown in FIG. 5A is a simplification for illustrative purposes and in fact three distinct sets 400 of minor tape 310 are wound at the same time, as shown for example in FIGS. 6 and 7.

As discussed in respect of FIG. 1, in the present example the liner 110 is provided by extruding HDPE to form a tubular layer. It will be appreciated that the liner 110 may be formed from other polymers or using other methods. The liner 110 provides an underlying layer which has an outer surface 510 onto which the set 400 of minor tapes 310₁₋₄ may be wound. In some embodiments the set 400 may be wound onto a different underlying layer.

The set 400 of tapes 310 are provided by a tape separator 520 which has a final guide roller 530 and a support beam 540. The final guide roller 530 has a rolling axis X-X around which the final guide roller 530 rotates. Three equally spaced blades 550₁₋₃ extend from the support beam 540. The blades 550₁₋₃ are perpendicular to the surface of the final guide roller 530 and each have a cutting edge 555. The support beam 540 is itself supported by a shaft member 560 which is attached to the final guide roller 530 thereby allowing the final guide roller 530 to rotate freely about the axis of the shaft member 560. The blades 550 are positioned in the path of a precursor reinforcement tape such that as the tape is urged past the blades 550, the precursor reinforcement tape is split along multiple parallel lines of its longitudinal axis whilst motion of the tape continues in the same direction. The cutting edge 555 is for slicing the precursor reinforcement tape to provide minor tapes 310 of equal width.

Aptly there is a common interblade spacing between each blade 550. Aptly the common interblade spacing may be equal to the expected width of an incoming unslit reinforcement tape divided by one more than the number of blades 550. Aptly the interblade spacing may alternatively vary between blades 550 thus there may be no common interblade spacing. The blade 550 is an example of a separator element. Aptly the blades 550 may be replaced by any separator element such as one or more circular blades (see FIGS. 9A and B for example), a laser cutter, a plasma cutter, or the like. In general the separator element is able to cut a precursor reinforcement tape into multiple longitudinally extending strips. The tape separator 520 is held in a fixed relative distance and angle from the central axis A-A.

In use, the tape separator 520 moves in a circular motion around the outer surface 510 of the underlying layer whilst the angle between the rolling axis X-X and the central axis A-A of the underlying layer remains constant. Meanwhile an incoming unsplit precursor reinforcement tape 570 contacts a cylindrical guide surface region 575 of the final guide roller 530 and is drawn in an anticlockwise direction around the rolling axis X-X by the anticlockwise rotating final guide roller 530. Then the unslit reinforcement tape 570 passes through the blades 550₁₋₃ where it is transformed into four minor tape elements 310₁₋₄. The minor tape elements 310₁₋₄ approach the outer surface of the liner 110 as respective incoming minor tape windings 580₁₋₄. The incoming minor tape windings 580₁₋₄ are laid in a tape lay direction 590 onto the outer surface of the liner 110. The minimal distance between when the minor tape elements 310₁₋₄ are formed, at the blades 550₁₋₃, and when the minor tape elements 310₁₋₄ are laid on the outer surface 510 helps to prevent gaps being introduced at the intra-tape set boundaries 320. Aptly the proximity of the tape separator 520 to the outer surface 510 of the underlying layer helps to maintain the zero gap 325 between minor tape elements 310 of a given set 400.

Thus as the minor tape elements 310 are helically wound around the liner 110 in the tape lay direction 590, the resulting underlying tape layer 120₁ is formed towards the output direction 340 (towards the right hand side of FIG. 5A). Once the process has been completed a partially completed RTP body is formed having the liner 110 and the underlying tape layer 120₁. Then, a similar process to that illustrated in FIG. 5A is completed, except that the minor tape elements 310 are wound in a clockwise direction to provide the overlying tape layer 120₂.

FIG. 6 illustrates part of the manufacturing process for making RTP body 100 in which the overlying tape layer 120₂ is wound over the underlying tape layer 120₁.

The manufacturing system includes three separate tape winding assemblies, each having a spool 610₁₋₃, a tape guiding system 620₁₋₃, a tape separator 520₁₋₃ and respective minor tape elements 310₁₋₁₂ (shown per set 400 of tapes for simplification). The tape winding assemblies are driven around the liner 110 (an example of a driven rotatable core member) which has a bore 115 (an example of a central through passageway). Aptly the central through passageway is aligned along an axis about which the core member is rotatable.

The spool 610 is for holding a reel of precursor reinforcement tape 570 and is rotatable about a reel axis of rotation Y-Y which is parallel to the rolling axis X-X of the tape separator 520 and each of the respective rotation axes of rollers that make up part of the tape guiding system 620. During the manufacturing process, the three tape winding assemblies are each rotatably driven in a clockwise direction around the bore 115 of the liner 110 such that the angle between the reel axis of rotation Y-Y / the rolling axis X-X and the central axis A-A remains constant.

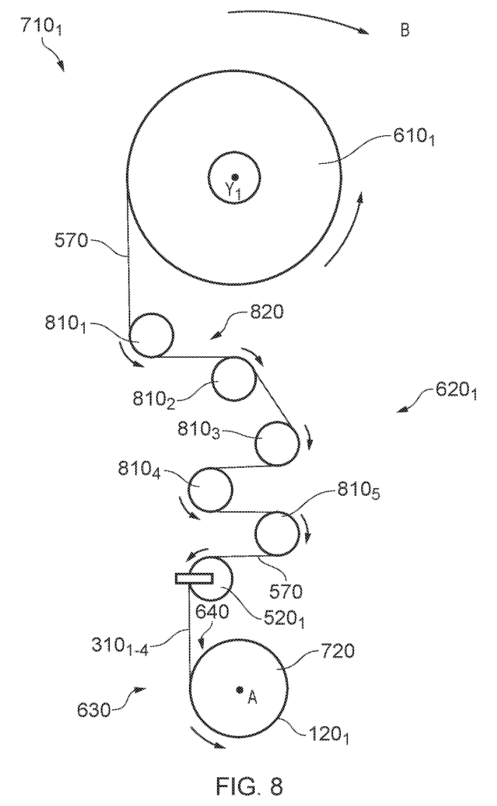

The tape guiding system 620 is shown in more detail in FIG. 8. The system 620 effectively serves as a way for precursor reinforcement tape 570 to be guided under tension from the spool 610, separated into multiple minor tapes 310, and directed onto the outer surface of the liner 110. It will be appreciated that whilst six guide rollers are shown in each tape guiding system 620 there could alternatively be any number of rollers. Aptly whilst FIG. 6 shows three spools 610₁₋₃ and three tape guiding systems 620₁₋₃ there could alternatively be two, four, five, or more. It will be appreciated that the number is mainly affected by the lay angle of the tape and the width of the tape.

Precursor reinforcement tape 570₁₋₃ is fed from the respective spools 610₁₋₃ and through five satellite guide roller elements in the tape guiding systems 620₁₋₃. Then the precursor reinforcement tape 570₁₋₃ passes through the blades 550 of the tape separator 520₁₋₃ where it is split into three sets of minor tape elements 310₁₋₁₂. The sets of minor tape elements 310₁₋₁₂ are wound as incoming minor tape element windings 580₁₋₁₂ at a touchdown zone 630 onto an outer surface 640 of the underlying tape layer 120₁. Aptly the touchdown zone 630 is defined between a first location of a first incoming minor tape element winding 580₁ of a first set 400 of minor tapes nearest the output direction 340 and a second location of a final incoming minor tape element winding 580₁₂ of a third set 400 of minor tapes further from the output direction 340. Aptly the touchdown zone 630 is a region on the outer surface 510 that any of the incoming minor tape windings 580₁₋₁₂ is in contact with.

FIG. 7 illustrates another view of the manufacturing process shown in FIG. 6 along the central axis A-A. There are three tape winding assemblies 710₁₋₃ which each include a respective spool 610₁₋₃, tape guiding system 620₁₋₃ and tape separator 520₁₋₃. FIG. 7 shows how the three tape winding assemblies 710₁₋₃ all rotate in a winding direction B about the central axis A-A. According to the present example in which the overlying tape layer 120₂ is wound, the winding direction B is clockwise. It will be appreciated that in other examples, such as but not limited to when the underlying tape layer 120₁ is wound, the winding direction B may be anticlockwise.

Each of the three tape winding assemblies 710₁₋₃ function in effectively the same way as will be explained in the following paragraphs.

The precursor major reinforcement tape 570 is stored as a reel that is held by the spool 610. The spool 610 is attached to the tape guiding system 620 and the tape separator 520. The three tape winding assemblies 710 are rotatably secured to a base such that they rotate about a driven rotatable core member 720 which provides a central through passageway 730 that is aligned to the central axis a-a of the underlying layer 110. In the present example the liner 110 is the driven rotatable core member 720 upon which minor tapes 310 are wound.

The precursor major reinforcement tape 570 is driven from the spool 610 through the tape guiding system 620. The tape guiding system 620 includes a number of satellite guide roller elements, which are shown in FIG. 8. The satellite guide roller elements guide the precursor major reinforcement tape 570 along a pathway towards the tape separator 520. At the tape separator 520, immediately after being guided by the final guide roller 530, the precursor major reinforcement tape 570 is directed towards the blades 550 (each an example of a separator element). The blades 550 separate the precursor major reinforcement tape 570 into four strip portions. By providing continuous through cuts that separate the strip portions, the four minor tapes 310 are formed in one set 400. The four minor tapes 310 are disposed in an edge wise side-by-side relationship with zero gap 325 between them.

The resulting minor tapes 310 are helically wound at the touchdown zone 630 onto the outer surface 640 of the underlying tape layer 120₁. It will be appreciated that minor tapes 310 may alternatively be helically wound over any underlying layer such as a tubular layer / liner 110 (as shown in FIG. 5A), barrier layer, sheath, or the like. Aptly a precursor reinforcement tape 570 may be separated into two, three, four, five, six or more minor tapes 310 depending on the number of blades 550.

The process described above is carried out simultaneously in each of the three tape winding assemblies 710₁₋₃, providing three sets 400 (set A, set B, set C) of minor tape windings on the outer surface 640 of the underlying tape layer 120₁. Meanwhile the three tape winding assemblies 710₁₋₃ – and thus the three spools 610₁₋₃ – are rotatably driven in a circular path defined by the winding direction B around the bore 115 (an example of a through passageway). Thus the overlying tape layer 120₂ is provided.

FIG. 8 illustrates diagrammatically the path of tape elements in the first tape winding assembly 710₁ from the precursor reinforcement tape 570 held by the first spool 610₁ at the top of the figure downwards to the eventual touchdown zone 630 of the four minor tapes 310₁₋₄ on the outer surface 640 of the driven rotatable core member 720 (in this example this is the underlying tape layer 120₁). The first tape winding assembly 710₁ and the driven rotatable core member 720 rotate about the central axis A in the winding direction B. The driven rotatable core member 720 thus does not move linearly in the plane of FIG. 8.

The first tape guiding system 620₁ has five satellite guide roller elements 810₁₋₅ which guide the precursor major tape element 570 along a tape pathway 820 towards the tape separator 520. At each satellite guide roller 810, the path of the precursor major tape element 570 is deflected by contact with an outer surface of the guide roller 810. Aptly the precursor major tape element 570 is maintained in some tension. Aptly the tension may help to pull the tape from the spool 610. The spool 610 and the satellite roller elements rotate around the underlying tape layer 120₁ (or alternatively the tubular layer) in a constant spaced apart relationship. It will be appreciated that in other embodiments they may be as few as one satellite roller element 810 or more than five.

At the tape separator 520, the precursor reinforcement tape 570 is supported by the final guide roller 530 immediately before being urged past the separator elements. The separator elements separate the precursor reinforcement tape 570 that is in an unslit state into four strips. In particular, the cutting edges 555 of the blades 550 (not shown) continuously split the precursor tape 570 into four minor tape elements 310₁₋₄.

The four minor tape elements 310₁₋₄ are thereafter wound onto the outer surface 640 of the underlying tape layer 120₁ (an example of a tubular layer). It will be appreciated that alternatively the minor tape elements 310 may be wound onto the outer surface of the liner 110 or any other tubular layer. It should be noted that the distance from the separator elements (at the tape separator 520) to the touchdown zone 630 is minimal. This helps to prevent gaps being introduced between the minor tapes 310₁₋₄ after separation. Accordingly, the overlying tape layer 120₂ (or indeed any layer composed of helically wound minor tapes) is provided and extends out of the page centred on the central axis A.

FIGS. 9A and 9B illustrate an alternative method for helically winding tape in which the tape separator 520 is replaced by a circular cutter roller 910. The circular cutter roller 910 includes a final guide roller 920 and three parallel circular radially outwardly extending blades 930₁₋₃ (each an example of a separator element). The final guide roller 920 is a cylindrical guide roller body that has a curved outer surface. The circular blades 930₁₋₃ are spaced apart at regular intervals by a common interblade spacing. The circular blades 930₁₋₃ each have a radially extreme cutting edge 935 that extends around the cylindrical outer surface of the final guide roller 920. As is shown in FIG. 9B, the final guide roller 920 is mounted on a shaft 940 which allows the roller 920 to rotate about a roller body rotation axis Z-Z.

Aptly the circular cutter roller 910 may alternatively have one, two, three, four or more circular radially outwardly extending blades 930. Aptly the circular radially outwardly extending blades 930 may not have a common interblade spacing, instead having different separation distances between each blade 930. Aptly the radially extreme cutting edge 935 of the circular blade 930 may be serrated, have square teeth, or the like.

The curved outer surface of the circular cutter roller 910 is made up of four coaxial guide surface regions 950₁₋₄ of equal diameter. Each guide surface region 950₁₋₄ is separated and spaced apart from a neighbouring region by a respective circular blade 930₁₋₃. The guide surface regions 950₁₋₄ all lie on an imaginary cylinder of common radius and have an equal width. Aptly, where the circular radially extending blades 930 do not have a common interblade spacing, the width of each guide surface region 950 may vary accordingly.

In use the circular cutter roller 910 functions similarly to the previously-described tape roller 520 in that precursor reinforcement tape 570 is continuously urged past the circular cutter roller 910 and output as four minor tape elements 310₁₋₄. The precursor reinforcement tape 570 first contacts the radially extreme cutting edges 935 of each circular radially outwardly extending blade 930₁₋₃ which split the precursor tape 570 into four strip portions that are minor tapes 310₁₋₄. The minor tapes 310₁₋₄ are guided on the guide surface regions 950₁₋₄, affecting the pathway of the tapes. The minor tapes 310₁₋₄ then leave the guide surface regions 950₁₋₄ moving in the tape lay direction 590.

The four minor tapes 310₁₋₄ approach the outer surface 510 of the liner 110 (an example of a tubular layer) as respective incoming minor tape windings 580₁₋₄ where they are helically wound around the liner 110. The minimal distance between when the minor tape elements 310₁₋₄ are formed, at the circular blades 930₁₋₃, and when the minor tape elements 310₁₋₄ are laid on the outer surface 510 helps to prevent gaps being introduced at the intra-tape set boundaries 320. Aptly the proximity of the circular cutter roller 910 to the outer surface 510 of the underlying layer helps to maintain the zero gap 325 between minor tape elements 310 of a given set 400. The resulting underlying tape layer 120₁ is urged in the output direction 340 as more tape layer is provided by the same process. This approach can also be used to make the overlying tape layer 120₂ or any layer composed of minor tape 310 windings. Aptly the minor tape 310 may be wound over any tubular layer.

As noted previously, it will be appreciated that various other types of tape separator devices may be alternatively provided with different separator elements. For example, a laser cutter, plasma cutter, band saw, or the like may be a separator element that can be used to separate strip portions of a precursor reinforcement tape for providing a plurality of flexible minor tapes.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader’s attention is directed to all papers and documents which are filed concurrently with or previous to this specification in connection with this application and which are open to public inspection with this specification, and the contents of all such papers and documents are incorporated herein by reference.

While certain arrangements of the inventions have been described, these arrangements have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, arrangement, or example are to be understood to be applicable to any other aspect, arrangement or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing arrangements. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some arrangements, the actual steps taken in the processes illustrated and/or disclosed may differ from those shown in the figures. Depending on the arrangement, certain of the steps described above may be removed, others may be added. Furthermore, the features and attributes of the specific arrangements disclosed above may be combined in different ways to form additional arrangements, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular arrangement. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain arrangements include, while other arrangements do not include, certain features, elements, and/or steps. Thus, such conditional language is not generally intended to imply that features, elements, and/or steps are in any way required for one or more arrangements or that one or more arrangements necessarily include logic for deciding, with or without user input or prompting, whether these features, elements, and/or steps are included or are to be performed in any particular arrangement.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain arrangements require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may be used to refer to an amount that is within less than 10% of the stated amount. As another example, in certain arrangements, the terms “generally parallel” and “substantially parallel” refer to a value, amount, or characteristic that departs from exactly parallel by less than or equal to 15°, 10°, 5°, 3°, 1 degree, or 0.1 degree. The ranges disclosed herein also encompass any and all overlap, sub-ranges, and combinations thereof, and any specific values within those ranges. Language such as “up to,” “at least,” “greater than,” “less than,” “between,” and the like includes the number recited. Numbers and values used herein preceded by a term such as “about” or “approximately” include the recited numbers. For example, “approximately 7 mm” includes “7 mm” and numbers and ranges preceded by a term such as “about” or “approximately” should be interpreted as disclosing numbers and ranges with or without such a term in front of the number or value such that this application supports claiming the numbers, values and ranges disclosed in the specification and/or claims with or without the term such as “about” or “approximately” before such numbers, values or ranges such, for example, that “approximately two times to approximately five times” also includes the disclosure of the range of “two times to five times.” The scope of the present disclosure is not intended to be limited by the specific disclosures of preferred arrangements in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method of manufacturing a flexible pipe member, comprising:
providing a tubular layer;
for each of at least one precursor reinforcement tape, via a respective at least one separator element, separating at least a first strip portion of a respective precursor reinforcement tape from a further strip portion thereby providing a plurality of minor tapes, each corresponding to a respective strip portion, disposed in an edge wise side-by-side relationship; and
helically winding the minor tapes simultaneously in an edge wise side-by-side relationship over an outer surface of the tubular layer thereby providing a reinforcement layer over the tubular layer.

2. The method as claimed in claim 1, further comprising:
drawing supply tape, for providing respective reinforcement tape, that is in an unslit state and that has a supply tape edge-to-edge width from a respective roll of supply tape supported via a respective spool member;
as the spool member is rotated around the tubular layer, urging supply tape past a plurality of separator elements that each comprise a blade having a respective cutting edge, said separator elements being disposed in a spaced apart parallel relationship and at a location between the spool member and a touchdown zone where incoming minor tape windings touch the outer surface; and
slitting the supply tape via blades of the separator elements thereby separating strip portions of precursor reinforcement tape.

3. The method as claimed in claim 2, further comprising:
supporting the precursor reinforcement tape between the spool member and the separator elements via at least one guide roller element that each rotate around the tubular layer in a constant spaced apart relationship with the spool member; and
via a final guide roller element that is a guide roller element of the at least one guide roller element that immediately precedes the separator elements in a precursor reinforcement tape pathway, directing precursor reinforcement tape to the separator elements, said separator elements being supported on a support member that has a constant spaced-apart relationship with a rolling axis of the final guide roller element.

4. The method as claimed in claim 1, further comprising:
drawing supply tape, for providing respective reinforcement tape, that is in an unslit state and that has a supply tape edge-to-edge width from a respective roll of supply tape supported via a respective spool member ;
as the spool member is rotated around the tubular layer, urging supply tape over a guide roller element, that comprises at least one circumferentially extending blade that comprises a respective cutting edge and that extends radially outwardly from the guide roller element, disposed at a location between the spool member and a touchdown zone where incoming minor tape windings touch the outer surface; and
slitting the supply tape via each cutting edge thereby separating strip portions of precursor reinforcement tape.

5. The method as claimed in claim 4, further comprising:
supporting the precursor reinforcement tape between the spool member and the separator elements via at least one guide roller element that each rotates around the tubular layer in a constant spaced apart relationship with the spool member; and
via a final guide roller element that is a guide roller element of the at least one guide roller element that immediately precedes the touchdown zone in a precursor reinforcement tape pathway, slitting precursor reinforcement tape via the at least one circumferentially extending blade and supporting and thereby guiding each resultant minor tape on a region of a respective at least one circumferentially extending guide surface that extends circumferentially around the final guide roller element.

6. The method as claimed in claim 1, further comprising:
separating strip portions via slitting the precursor reinforcement tape thereby simultaneously cutting through precursor reinforcement tape having a first edge-to-edge width thereby simultaneously cutting continuous through cuts made in an axial direction associated with a length of precursor reinforcement tape via at least one blade, that optionally comprises a plurality of spaced apart blades, thereby providing a plurality of minor tapes each having an edge-to-edge width less than the first edge-to-edge width.

7. A flexible pipe member for transporting production fluids, comprising:
a tubular layer comprising an outer surface; and
a reinforcement layer, over the tubular layer, that comprises a plurality of flexible minor tapes helically wound around the outer surface; wherein
in an axial cross section through the reinforcement layer, the minor tapes repeat a pattern of abutting minor tapes, comprising at least one pair of minor tapes being disposed in an edge wise side-by-side abutting relationship, and overlapped minor tapes comprising a minor tape wound flat against the outer surface and an adjacent minor tape having an overlapping edge region wound partially overlapping an overlapped edge region of the adjacent wound minor tape that is wound flat.

8. The flexible pipe member as claimed in claim 7, further comprising:
the pattern in the axial cross section comprises a common number of abutting minor tapes and overlapped minor tapes along a whole or at least 60% of a whole length of the reinforcement layer.

9. The flexible pipe member as claimed in claim 7, further comprising:
the pattern in the axial cross section comprises at least a repeated first integer number of abutting minor tape windings and a repeated further integer number, that is different from the first integer number, of abutting minor tape windings that are separated from the abutting minor tape windings of the first integer number of abutting minor tape windings by a pair of overlapping minor tape windings that are partially overlapping at respective edge regions.

10. The flexible pipe member as claimed in claim 7, further comprising:
each minor tape element is a helically wound tape wound at a common pitch and a common winding angle with respect to a primary axis associated with an axial length of the tubular layer.

11. The flexible pipe member as claimed in claim 7, further comprising:
the plurality of minor tapes are wound as a set of minor tapes, each minor tape winding in a set having at least one edge that abuts with an edge of an adjacent minor tape winding of the set.

12. The flexible pipe member as claimed in claim 11, further comprising:
at least one extreme minor tape, that is a minor tape in a set that is on a lateral width-wise extremity of the minor tapes in a set of minor tapes, partially overlaps with or partially underlies with an adjacent extreme minor tape of an adjacent set of minor tape windings.

13. The flexible pipe member as claimed in claim 7, further comprising:
each minor tape has an edge-to-edge width of between about around 10mm to 50mm that is a common width along a whole axial length of the minor tape.

14. The flexible pipe member as claimed in claim 7, further comprising:
the precursor reinforcement tape has a thickness to width aspect ratio of between 1:500 and 1:50 and the minor tapes each have a respective thickness to width aspect ratio of between 1:100 and 1:10.

15. Apparatus for providing a plurality of flexible tape elements at a desired location, comprising:
a guide roller element comprising a guide roller body that includes at least one circumferentially extending cylindrical guide surface region on a radially outer surface of the guide roller element, and at least one shaft member associated with a respective roller body rotation axis; and
at least one separator element each supported in a respective preset position in relation to the guide surface region and disposed to separate strip portions of a precursor reinforcement tape for providing a plurality of flexible minor tapes, each having a constant longitudinal cross-section, in an edge wise side-by-side relationship.

16. The apparatus as claimed in claim 15, further comprising:
each separator element of the at least one separator element comprises a blade, with a respective cutting edge, that extends from a support beam supported at at least one end to the shaft member.

17. The apparatus as claimed in claim 16, further comprising:
the at least one separator element comprises a plurality of blades, each having a respective cutting edge, disposed in a commonly spaced apart relationship, a common interblade spacing associated with the spaced apart relationship being an integral division of an expected width of an incoming precursor reinforcement tape to thereby separate a precursor reinforcement tape into an integral number of equal width minor tapes.

18. The apparatus as claimed in claim 15, further comprising:
said at least one circumferentially extending cylindrical guide surface region comprises a single cylindrical guide surface region that is smooth or includes one or more circumferentially extending ribs or grooves that is for presenting a support surface to an incoming precursor reinforcement tape.

19. The apparatus as claimed in claim 15, further comprising:
the at least one separator element comprises a plurality of separator elements and each separator element of the plurality of separator elements comprises a circular radially outwardly extending blade each having a respective radially extreme cutting edge and that extends circumferentially around the guide roller body and is disposed at a respective side of at least one associated cylindrical guide surface region.

20. The apparatus as claimed in claim 15, further comprising:
the at least one guide surface region comprises a plurality of guide surface regions that are coaxial and all lie on an imaginary cylinder of common radius and have an equal width, said guide surface regions being spaced apart via circular blades.
